(19) United States
(12) Patent Application Publication
(10) Pub. No.: US 2014/0012939 A1
(43) Pub. Date: Jan. 9, 2014

(54) METHOD FOR PROVIDING RESOURCES BY A TERMINAL, AND METHOD FOR ACQUIRING RESOURCES BY A SERVER

(71) Applicants: Seungkyu Park, Anyang-si (KR); Seongyun Kim, Anyang-si (KR); Rama Gopala Raju Nallapa Raju, Bangalore (IN)

(72) Inventors: Seungkyu Park, Anyang-si (KR); Seongyun Kim, Anyang-si (KR); Rama Gopala Raju Nallapa Raju, Bangalore (IN)

(73) Assignee: LG ELECTRONICS INC., Seoul (KR)

(21) Appl. No.: 14/005,802

(22) PCT Filed: Mar. 16, 2012
(86) PCT No.: PCT/KR2012/001897

§ 371 Date: Sep. 17, 2013

Related U.S. Application Data
(60) Provisional application No. 61/453,552, filed on Mar. 17, 2011.
(60) Provisional application No. 61/554,975, filed on Nov. 3, 2011.

(51) Int. Cl. G06F 15/167

(52) U.S. Cl. CPC G06F 15/167
USPC 709/213

(57) ABSTRACT

A method for caching a DM tree includes determining whether a cache validator of a first type for a first resource exists, wherein the cache validator of the first type is directly used for the first resource; determining whether a cache validator of a second type for the first resource exists, wherein the cache validator of the second type is used for a second resource including the first resource, when the cache validator of the first type for the first resource does not exist; and transmitting a request for the first resource to the device management client using an identifier for the first resource, an identifier for the second resource and the cache validator for the second resource, when the cache validator of the second type for the first resource exists.

### TECHNICAL FIELD

The present invention relates to a resource providing method, terminal using the resource providing method, resource obtaining method and server using the resource obtaining method.

### BACKGROUND ART

There is a device management (DM) technology of OMA (open mobile alliance) as a representative technology for mobile terminal management. According to the DM, device management is performed in a manner of opening an interactive session between a DM server and a DM client and then exchanging DM commands through this session. In order to open this DM session, the DM client can initiate a session for the DM server through Package 1. On the contrary, if the DM server determines that a terminal management is necessary, the DM server can make a request for DM session to the DM client by sending DM notification called Package 0. In case of receiving the DM notification from the DM server, the DM client can initiate the DM session by sending Package 1 to the DM server.

Transport-binding supported by a DM protocol may currently include one of HTTP-binding, OBEX-binding, WSP-binding and the like. A transport binding protocol is a sort of a deliverer used to deliver semantic of the DM protocol between DM client and DM server. And, HTTP-binding is a scheme of delivering DM protocol using HTTP protocol. Recently, in order to deliver DM protocol, REST-binding is taken into consideration. In particular, combining DM protocol with REST-binding may be called RESTful DM. In order to understand RESTful DM, it is necessary to know REST architecture and the meaning of RESTful. REST (REpresentational State Transfer) may be regarded as a sort of software or a sort of design pattern for designing protocol architecture. And, the features of REST include a client-server structure, not using session/cookie (stateless), cacheable, layered system, and uniform interface. If a software or protocol architecture meets these features, it can be represented as following the REST principle, which is abbreviated RESTful. In particular, a system, protocol or software, which meets the above-enumerated five features, can be expresses as RESTful.

Such a RESTful system has various advantages. And, the various advantages include high scalability, generality of interfaces, independent deployment of resources, and intermediary resource utilizing a layered system. RESTful DM may be defined as completely different from DM HTTP-binding, strongly combined with HTTP to transport DM protocol (transition of DM commands to HTTP commands), conforming with REST principles, and enjoying the benefits of being RESTful.

FIG. 1 is a schematic diagram of RESTful DM.

In RESTful DM, HTTP commands are used to deliver DM protocol between a DM server and a DM client. In this case, the DM client sends DM Get command to a specific resource (e.g., structure and leaf node data for ‘./scomo’ of DM tree) using the HTTP GET command The DM server uses HTTP status code ‘200 OK’ to indicate that a request made by the DM client has been correctly handled. The DM then sends a requested data. In doing so, in order to send the corresponding data, JSON (JavaScript Object Notation) format is used. Since RESTful DM is not standardized yet, details shown in FIG. 1 may be different from the specification of RESTful DM.

RESTful DM can use resource caching mechanism, which is used by HTTP, without special DM protocol amendment. This HTTP caching increases a response speed between HTTP server and HTTP client (i.e., low latency) and is able to reduce network traffics. For HTTP caching, HTTP client caches a resource, which is transported from HTTP server, in a local. When a request is made to the same URI again, only if the corresponding resource is modified, the HTTP client receives the resource from the HTTP server again. To this end, a method of determining whether the corresponding resource is modified is required. In order to check whether the resource is modified, a cache validator is used. In HTTP, ETag and Last-Modified are representatively used as cache validators.

ETag is a sort of an identifier given to a resource of a specific version by HTTP server. If the HTTP server receives a request for URI, the HTTP server sends a resource indicated by the URI and an ETag value given to the resource both. If a resource is modified (i.e., if a version of the resource is changed), the HTTP server modifies an ETag value. In particular, if the HTTP client makes a request for the same URI, the HTTP server determines whether the resource cached by the HTTP server is a latest (fresh) version in a manner of comparing an ETag value sent by the HTTP client to an ETag value retained by the HTTP server. If the HTTP client has the latest (fresh) version of the resource, it is unnecessary for the HTTP server to send the resource again.

Table 1 in the following schematically shows HTTP caching using ETag.

TABLE 1
Request
Get http://www.server.com/a.jpg HTTP/1.1// other headers here
Response
HTTP/1.1 200 OK...ETag: “686897696a7c876b7e”...// start of body
Request
GET http://www.server.com/a.jpg HTTP/1.1...If-None-Match:
“686897696a7c876b7e”...
Response
HTTP/1.1 304 Not Modified

Referring to Table 1, HTTP client makes a request for an image file resource ‘a.jpg’ through URI ‘http://www.server.com/a.jpg’. HTTP transmits an image file, which is the requested resource, in a manner that HTTP header called ETag is contained in the image file. This ETag header indicates an ETag value given to a current version of the image file resource. The HTTP client receives a response and then caches the image file resource in a local. And, the HTTP client caches the ETag value as well. When the HTTP client makes a request for the same URI, the HTTP client controls the cached ETag to be included in the request. To this end, HTP header called ‘If-None-Match’ is used. Having received this request, the HTTP server compares the received ETag to an ETag value for a current version of a resource indicated by URI. If the two values are equal to each other, the HTTP server informs the HTTP client that the resource is not modified. Having received such a response from the HTTP server, the HTTP client verifies that the resource currently cached by the HTTP client is a latest (fresh) version and then uses the corresponding resource without receiving a latest (fresh) version of the resource from the server again.

As a mainly used HTTP cache validator except ETag, there is Last-Modified. Table 2 in the following schematically shows HTTP caching using Last-Modified.

TABLE 2
Request
Get http://www.server.com/a.jpg HTTP/1.1 // other headers here
Response
HTTP/1.1 200 OK...Last-Modified: Tue, 15 Nov 1994 12:45:26 GMT...//
start of body
Request
GET http://www.server.com/a.jpg HTTP/1.1...If-Modified-Since: Tue,
15 Nov 1994 12:45:26 GMT...
Response
HTTP/1.1 304 Not Modified

Referring to Table 2, basic operation of Last-Modified is almost identical to that of ETag. Regarding the difference between the Last-Modified and the ETag, the Last-Modified means a time at which a resource is modified last, while the ETag is a random identifier given to a specific version of the resource. In particular, when HTTP server transmits a resource to HTTP client, the HTTP server controls a last modified time of the resource to be included in a Last-Modified header. The HTTP client caches a Last-Modified value in a local. When the HTTP client makes a request for a same URI, the HTTP sends the request in a manner that a last modified time of the received resource is contained in If-Modified-Since header. Each time a resource is modified, the HTTP server updates a resource modified time. If the request for the same URI contains the If-Modified-Since header, the HTTP server compares the corresponding time to a time managed by the HTTP server. If the HTTP server determines that the resource has been modified, the HTTP server retransmits the resource.

In HTTP caching which uses ETag as a cache validator, it is checked whether a resource cached by HTTP client is a latest (fresh) version in a manner of comparing ETag of HTTP server to ETag of the HTTP client. When the ETags are compared to each other, it is noted that ETags for the same URI should be compared to each other. In particular, although ETag values of different URIs may be equal to each other, such a comparison is meaningless. This is identically applied to Last-Modified cache validators as well. The comparison of Last-Modified for the same URI is meaningful only.

HTTP caching may be applicable to RESTful DM. This is one of advantages or benefits when a specific protocol follows REST architecture. Table 3 in the following shows application of HTTP caching to RESTful DM, in which ETag is used as a cache validator.

TABLE 3
Request
Get http://dev_ip:dm_port/SCOMO/Download?list=StructData HTTP/1.1
Response
HTTP/1.1 200 OKETag: “686897696a7c876b7e”// http body here for
the content
Request
GET http://dev_ip:dm_port/SCOMO/Download?list=StructData
HTTP/1.1If-None-Match: “686897696a7c876b7e”
Response
HTTP/1.1 304 Not Modified

An application scheme for a case of using Last-Modified as a cache validator is almost similar to a scheme using ETag. DM server makes a request for a specific resource to DM client. Like HTTP, the requested resource is represented as URI. In Table 3, a download subtree of SCOMO is requested through URI ‘http://dev_ip:dm_port/SCOMO/Download?list=StructData’. The DM client sends a download subtree resource together with a status code ‘200 OK’. In doing so, the DM client sends an ETag value as well. When the DM server makes a request for the same URI, the DM server sends an ETag value for a cached resource through an HTTP header called If-None-Match. Having received the corresponding request, the DM client compares ETag values to each other. As a result of the comparison, if the DM client determines that the download subtree resource has been modified, the DM client performs retransmission. In Table 3, since the ETags match each other, the DM client transmits a status code ‘304 Not Modified’.

RESTful DM of applying REST architecture to DM protocol has a considerable benefit of resource caching. This is possible by applying HTTP caching of HTTP protocol, of which example is explained in the above description with reference to Table 3.

Table 4 in the following shows another example of caching a resource of DM using HTTP caching in RESTful DM.

TABLE 4
Request
Get http://dev_ip:dm_port/SCOMO/Download?list=StructData
HTTP/1.1If-None-Match: “686897696a7c876b7e”
Response
HTTP/1.1 304 Not Modified
Request
GET http://dev_ip:dm_port/SCOMO/Download?list=StructData
HTTP/1.1
Response
HTTP/1.1 200 OKETag: “12122211212wefwef2”// http body here for
the content

Referring to Table 4, DM server makes a request for a download subtree resource of SCOMO through URI of ‘http://dev_ip:dm_port/SCOMO/Download?list=StructData’. In doing so, the DM server delivers an ETag value for a version of a resource, which is cached by the DM server, in a manner that If-None-Match HTTP header is contained in the request. Subsequently, DM client compares the ETag values to each other. If the compared ETag values are equal to each other, the DM client sends a status code ‘303 Not Modified’ to notify that a resource retained by the DM server is a latest (fresh) version. Since a version of a resource retained by the DM server is the latest (fresh) version, the DM server uses the cached resource, The DM server makes a request for a subtree resource ‘SCOMO/Download/Email’ through a URI ‘http://dev_ip:dm_port/SCOMO/Download/Email?list=StructData’ again. Since different URIs indicate different resources in HTTP caching, respectively, this request is regarded as a new request for a completely different resource. Hence, the DM server sends a request without ETag and the DM client then sends the subtree resource ‘SCOMO/Download/Email’ in response to the request.

Yet, in the resource caching scenario of RESTful DM shown in Table 4, a 2^{nd} response of the DM client, which sends the subtree resource ‘SCOMO/Download/Email’ is not necessary. This is because the 2^{nd} requested resource is a subset of the 1^{st} requested resource. In particular, since the 1^{st} resource requested by the DM client includes the 2^{nd} resource and there is no update in the course of the request occurrence, the DM server can be regarded has the latest (fresh) version of the 2^{nd} requested resource in the local. Yet, since HTTP caching mechanism determines a request for a difference URI as a request for a separate resource, the two resources requested by the DM server are classified as separate resources. Hence, the caching mechanism is not applicable thereto. This is because a resource handled by HTTP and a resource handled by DM have different properties, respectively. DM protocol mainly handles a DM tree as a resource. And, in the DM tree, one resource contains another resource in general through a parent-to-child node relationship. Such an inclusive relationship between DM resources is called inclusive relationship, which is a unique feature of the DM resource. And, the HTTP resource does not have such a unique feature. Although ETag is used as a validator in Table 4, the same problem may be caused in case of using Last-Modifier.

Since resource caching of RESTful DM using HTTP caching does not consider the above-mentioned inclusive relationship, it is not efficient. Since the DM client transmits a resource, which is not necessary to be transmitted, in the 2^{nd} response, as shown in Table 4, network bandwidth is wasted, response time increases, and power consumption of the DM client is raised.

### DISCLOSURE OF THE INVENTION

### Technical Task

The present invention relates to a method of caching a DM tree which is a primary DM resource exchanged between a DM server and a DM client. And, one object of the present invention is to provide a method of caching a DM resource in consideration of an inclusive relationship between DM resources (accompanied with changes of operations of the DM server and the DM client).

Another object of the present invention is to provide a method of caching a DM resource irrespective of a type of a cache validator used by a cache mechanism. A further object of the present invention is to provide a method of caching a DM resource irrespective of subordinate transport binding (e.g., REST-binding, HTTP-binding, OBEX-binding, etc.) used by a DM protocol.

### Technical Solutions

To achieve these and other advantages and in accordance with the purpose of the present invention, as embodied and broadly described, a method of obtaining a resource, which is obtained by a device management server from a device management client, according to one embodiment of the present invention includes the steps of determining whether a cache validator of a 1^{st} type for a 1^{st} resource exists, wherein the cache validator of the 1^{st} type is directly used for the 1^{st} resource, if the cache validator of the 1^{st} type for the 1^{st} resource does not exist, determining whether a cache validator of a 2nd type for the 1^{st} resource exists, wherein the cache validator of the 2^{nd} type is used for a 2^{nd} resource including the 1^{st} resource, and if the cache validator of the 2^{nd} type for the 1^{st} resource exists, transmitting a request for the 1^{st} resource to the device management client using an identifier for the 1^{st} resource, an identifier for the 2^{nd} resource and the cache validator for the 2^{nd} resource.

According to one embodiment, a 1^{st} node associated with the 1^{st} resource and a 2^{nd} node associated with the 2^{nd} resource are included in a device management tree.

According to one embodiment, the step of determining whether the cache validator of the 2^{nd} type for the 1^{st} resource exists includes the steps of searching a current node for the cache validator of the 2^{nd} type for the 1^{st} resource, setting a parent node of the current node to the current node, and repeating the searching step and the setting step until the cache validator of the 2^{nd} type for the 1^{st} resource is initially found, wherein the current node is initially set to a parent node of the 1^{st} node.

According to one embodiment, the step of determining whether the cache validator of the 2^{nd} type for the 1^{st} resource exists includes the step of searching at least one cache validator of the 2^{nd} type for the 1^{st} resource from a parent node of the 1^{st} node to a root node of the device management tree.

According to one embodiment, the step of determining whether the cache validator of the 2^{nd} type for the 1^{st} resource exists includes the step of selecting the cache validator of the 2^{nd} type for the 1^{st} resource from the at least one cache validator of the 2^{nd} type for the 1^{st} resource.

According to one embodiment, each of the 1^{st} resource and the 2^{nd} resource includes a network data object or service identifiable by a corresponding identifier.

According to one embodiment, the resource obtaining method of the device management server further includes the step of if the cache validator of the 1^{st} type for the 1^{st} resource exists, transmitting the request for the 1^{st} resource to the device management client using an identifier for the 1^{st} resource and the cache validator for the 1^{st} resource.

According to one embodiment, the resource obtaining method of the device management server further includes the step of if the cache validator of the 1^{st} type for the 1^{st} resource does not exist, transmitting the request for the 1^{st} resource to the device management client using an identifier for the 1^{st} resource.

To further achieve these and other advantages and in accordance with the purpose of the present invention, a method of providing a resource, which is provided to a device management server by a device management client, according to one embodiment of the present invention includes the steps of receiving a request for a 1^{st} resource from the device management server, wherein the request includes a cache validator of a 1^{st} type or a 2^{nd} type for the 1^{st} resource, wherein the cache validator of the 1^{st} type is directly used for the 1^{st} resource, and wherein the cache validator of the 2^{nd} type is used for a 2^{nd} resource including the 1^{st} resource, when the request includes the cache validator of the 1^{st} type, if the cache validator of the 1^{st} type is valid for the 1^{st} resource, sending a message indicating that the 1^{st} resource is not modified to the device management server, and when the request includes the cache validator of the 2^{nd} type, sending the message to the device management server if the cache validator of the 2^{nd} type is valid for the 2^{nd} resource.

According to one embodiment, the step of sending the message if the cache validator of the 2^{nd} type is valid for the 2^{nd} resource, may optionally include the step of if the cache validator of the 1^{st} type for the 1^{st} resource cached in the device management client exists, sending the message using the cache validator of the 1^{st} type.

According to one embodiment, the resource providing method of the device management client further includes the step of if the cache validator of the 1^{st} type is not valid for the 1^{st} resource or the cache validator of the 2^{nd} type is not valid for the 2^{nd} resource, transmitting the 1^{st} resource to the device management client.

According to one embodiment, the 1^{st} resource transmitting step includes the step of if the cache validator of the 1^{st} type for the 1^{st} resource cached in the device management resource exists, transmitting the cache validator of the 1^{st} type together with the 1^{st} resource.

According to one embodiment, a 1^{st} node associated with the 1^{st} resource and a 2^{nd} node associated with the 2^{nd} resource are included in a device management tree.

According to one embodiment, each of the 1^{st} resource and the 2^{nd} resource includes a network data object or service identifiable by a corresponding identifier.

### Advantageous Effects

According to the present invention, when a DM server requests a non-cached resource, the present invention uses a cache validator of another resource including the requested resource to reduce DM resource transmission, thereby saving a network bandwidth and power consumption.

Moreover, the present invention is applicable irrespective of a specific cache validator (e.g., such a cache validator as ETag, Last-Modified, etc.) and can be advantageously combined with any transport binding.

### DESCRIPTION OF DRAWINGS

FIG. 1 is a schematic diagram for concept of RESTful DM.

FIG. 2 is a diagram of a device management architecture according to embodiments of the present invention.

FIG. 3 is a flowchart of a process for making a request using an inclusive cache validator in requesting a resource in RESTful DM according to one embodiment of the present invention.

FIG. 4 is a flowchart of a process for a DM client to handle a received request for a DM resource according to one embodiment of the present invention.

FIG. 5 (a) and FIG. 5 (b) are diagrams to show modified contents of a DM tree according to one embodiment of the present invention.

FIG. 6 is a flowchart of a process for updating a cache validator of a leaf node according to one embodiment of the present invention.

FIG. 7 is a flowchart of a process for updating a cache validator of an interior node according to one embodiment of the present invention.

FIG. 8 is a diagram for a concept of a process for updating a cache validator shown in FIG. 6 and FIG. 7.

FIG. 9 is a flowchart of a process for a DM server to make a request for a resource to a DM client by lightweight resource caching according to one embodiment of the present invention.

FIG. 10 is a flowchart of a process for a DM client to respond to a DM server by lightweight resource caching according to one embodiment of the present invention.

FIG. 11 is a flowchart of a process for a DM client 110 to send a response with PKG #1 according to one embodiment of the present invention.

FIG. 12 is a block diagram of a terminal 200 and a server 300 according to one embodiment of the present invention.

### BEST MODE FOR INVENTION

Reference will now be made in detail to a cache method usable when a DM server and a DM client exchange DM resources with each other. The present method relates to an efficient cache method in consideration of inclusive relationship between DM resources. To this end, an inclusive cache and an inclusive cache validator, which are the concepts used in DM resource caching, are described and a DM resource request and a DM resource response are then described in detail on the basis of a sequence.

In the following description, [HTTP 1.1] of RFC2616(http://www.w3c.org) named “Hypertext Transfer Protocol—HTTP/1.1”, [DM1.3] of OMA-TS-DM_Protocol-V1_{—}3 (http://www.openmobilealliance.org) named “OMA Device Management Protocol”, and [DM-HTTP-Binding] of OMA-TS-DM_HTTPBinding-V1_{—}3 (http://www.openmobilealliance.org) named “Device Management HTTP Binding” are used as references in the present specification.

In the following description, a resource may generally include a collection of an electronic document, an image, a server and other resources. A DM resource is a sort of resource exchanged between a DM server and a DM client for device management operations. In another aspect, a DM resource may include a network data object or service identifiable by a corresponding identifier. A DM tree (or a portion of DM tree) is a representative example of the DM resource. The DM resource is uniquely identified by URI. To this end, it is able to use absolute URI addressing.

Caching is a general terminology indicating a technology of saving a copy (e.g., a web cache) of a resource between servers and clients. A client caches a previous response from a server. If the same resource is requested, the client uses a copy of the corresponding resource.

When resources are exchanged, a server and a client use URI for identifying each resource. If URIs are different from each other, it means that no relationship exist between resources found from the URIs. Yet, in DM, DM resources of different URIs may be inclusively related to each other (i.e., in inclusive relationship). DM resource R1 of URI 1 may include DM resource R2 of another URI 2. For instance, DM tree resource identified by “./a/b?list=StructData” may include another DM tree source identified by “./a/b/c?list=StructData.

A cache validator is a component usable for cache validation. The cache validation is a process for determining whether a resource cached in a requestor is latest (fresh) or not. In this case, the terminology ‘latest (fresh)’ means that a resource has not been modified since it was transmitted to a requestor. Etag and Last-Modified fields are the representative examples of a cache validator used by a web cache.

If a cached resource includes a resource to be requested, the corresponding cache is an inclusive cache. In DM, resources may be in inclusive relationship and a resource R1 may include another resource R2. When a requestor requests R2, the requestor can use R1 as an inclusive cache despite not having a direct cache for R2.

If a cached resource is for a directly requested resource, the corresponding cache is a direct cache. This terminology is used to discriminate a direct cache from an inclusive cache. In web cache, every cache is a direct cache.

An inclusive cache validator is a cache validator used in validating an inclusive cache. Etag and Last-Modified fields can become inclusive cache validators.

A direct cache validator is a cache validator used in validating a direct cache. Etag and Last-Modified fields can become direct cache validators.

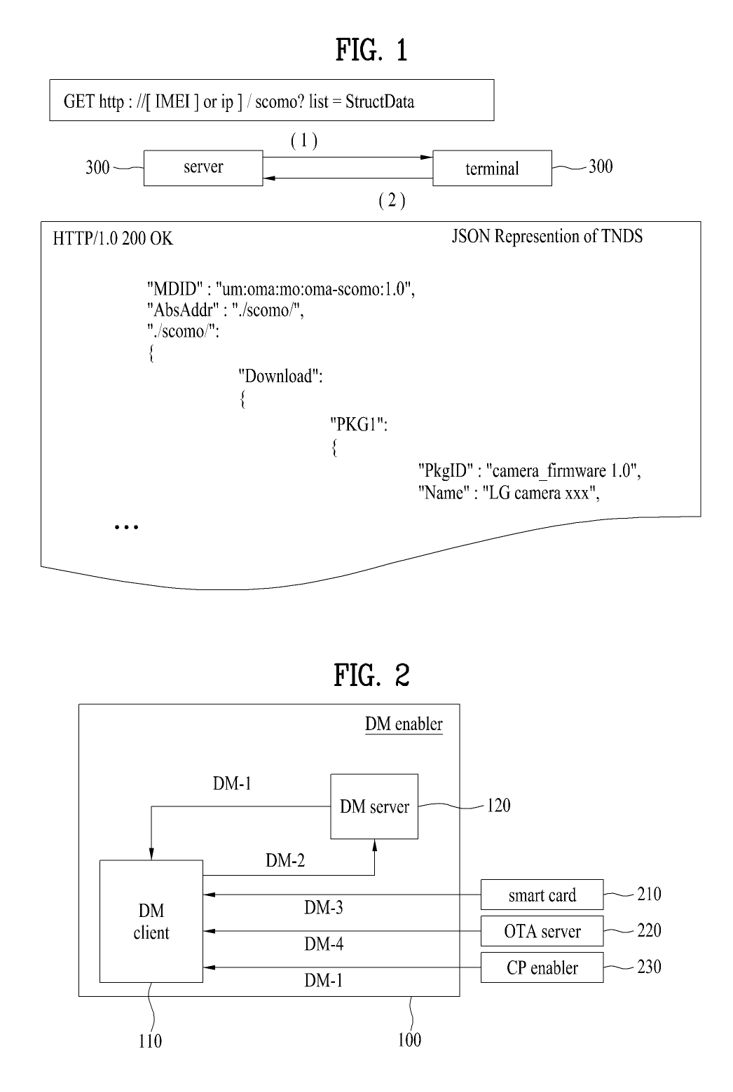

FIG. 2 is a diagram of a device management architecture according to embodiments of the present invention.

Device management (DM) is performed by a DM enabler 100 including a DM client 110 and a DM server 120.

The DM client 110 is an abstract software component that follows requirements for a DM client explicitly disclosed in OMA (open mobile alliance) device management enabler.

And, the DM server 120 is an abstract software component that follows requirements for a DM server explicitly disclosed in the OMA device management enabler.

A client-server notification DM-1 provides an interface for the servers 120 to send device management notification to the clients 110. The client-server notification DM-1 is an intermediate carrier and an interface that can operate by various protocols including WAP push, SIP push and the like.

A device management client-server protocol DM-2 provides an interface through which the servers 120 can send device management commands to the clients 110. And, through this interface, the clients 110 can send statuses and alarms to the servers 120. The device management client-server protocol DM-2 is an intermediate carrier and an interface for providing various kinds of standardized bindings including HTTP and HTTPS. This interface is exposed through a wireless connection-based data delivery protocol (e.g., GPRS) to provide wireless communication (over-the-air) device management performance.

In the early stage, the DM client 110 can be supplied through a file on a smart card 210. This file includes a series of DM commands for setting or changing configuration in the DM client 110. A DM boot strap profile DM-3 through the smart card 210 is a unidirectional interface that is not provided with a feedback from the DM client 110. The DM client 110 connected to the DM server 120 in a next substantial opportunity is a solely expected result.

The DM client 110 can be supplied through a file transmitted by several push protocols in the early stage. This file includes DM commands for setting or changing configuration in the DM client. A boot strap profile DM-4 is a unidirectional interface from an OTA server 220 to the DM client 110, which is not provided with a feedback from the DM client 11. The DM client 110 connected to the DM server 120 in a next substantial opportunity is a solely expected result.

The DM client 110 can be supplied through a CP enabler 230 in the early stage. A CP boot strap profile CP-1, which is not provided with a feedback from the DM client 110, is a unidirectional interface from the CP enabler 230 to the DM client 110. The DM client 110 connected to the DM server 120 in a next substantial opportunity is a solely expected result.

<Inclusive Cache & Inclusive Cache Validator>

RESTful DM uses HTTP protocol to send a DM message between the DM server 120 and the DM client 110. Although an existing DM transport binding using HTTP may include a DM HTTP binding [DM-HTTP-Binding], there are big differences between RESTful binding and DM HTTP binding. Although the RESTful DM may be conceptionally regarded as following REST architecture, an externally big difference lies in that the RESTful DM replaces a DM command by an HTTP method and then represents it in an HTTP header. In particular, in DM HTTP binding, a POST method is inserted in an HTTP header and the a command is put in an HTTP body, irrespective of an actual DM command. Yet, in RESTful DM, for example, a DM Get command is replaced by an HTTP GET method and is then inserted in an HTTP header. Thus, since the RESTful DM widely uses the related HTTP header, it can be more strongly combined with HTTP protocol and the advantages or benefits of the HTTP protocol can be used as they are. For instance, HTTP caching can be used in the RESTful DM.

RESTful DM replaces a DM command by an HTTP method. HTTP protocol delivers a specific method for a resource identified by URI. For simple example, ‘GET http://www.server.com/img.jpg’ can be taken into consideration. This brings a resource designated as URI ‘http://www.server.com/img.jpg’. Likewise, the RESTful DM delivers a DM message by sending URI and a method for the URI. In doing so, a DM resource should be uniformly represented with URI. This method has not been defined by OMA DM WG. Yet, the present invention uses a generally considerable method shown in Table 5. By this method, StructData attribute for a node represented as “./SCOMO/Download” in Absolute URI Addressing of DM can be represented as “http://dev_addr:dm_port/SCOMO/Download?list=StructData”.

TABLE 5

http://dev_addr:dm_port/
absolute_path_from_root?property_or_atrribute

If HTTP caching is usable for a resource of DM, it is one benefit of RESTful DM. Yet, if HTTP caching is exactly applied to DM, it may not be efficient. This is because there is inclusive relationship between DM resources despite no correlation between resources designated as URIs in HTTP. In particular, a relationship that a resource R1 designated as URI 1 includes a resource R2 designated as URI 2 is established in DM protocol.

Table 6 in the following shows the inclusive relationship between DM resources. Referring to Table 6, a resource indicated by ‘./a/b?list=Struct’ includes a resource indicated by ‘./a/b/c?list=Struct’. This table does not show all inclusive relationships of DM resources but shows examples of several inclusive relationships.

TABLE 6

| | | Whether |
|---|---|---|
| A | B | A includes B |
| ./a/b | ./a/b/c | Not included |
| ./a/b?list=Struct | ./a/b/c?list=Struct | Included |
| ./a/b?list=StructData | ./a/b/c?list=StructData | Included |
| ./a/b?list=StructData | ./a/b/c?list=Struct | Included |
| ./a/b?list=Struct | ./a/b/c?list=StructData | Not included |
| ./a/b?list=MORoot | ./a/b/c?list=MORoot | Included only if MO |
| | | identifiers are equal |
| | | to each other |
| ./a/b?list=MORootData | ./a/b/c?list=MORootData | Included only if MO |
| | | identifier and a |
| | | requested leaf node |
| | | are equal to each |
| | | other |
| ./a/b?list=TNDS | ./a/b/c?list=TNDS | Included |

Therefore, when a DM resource is exchanged between a DM server and a DM client, if such an inclusive relationship between DM resources is taken into consideration, it is able to make a more efficient caching mechanism. In HTTP, resources having different URIs are regarded as different resources and comparison between cache validators of these resources are regarded as meaningless. On the contrary, in DM, if cache validators for resources having different URIs are compared to each other in consideration of the inclusive relationship, it is able to enhance efficiency of cache mechanism. To this end, the concept of a direct cache and an inclusive cache is introduced into the present invention. In particular, the direct cache is the cache concept accepted by an existing HTTP protocol. When a resource of URI 1 is requested, the direct cache corresponds to a case of having a direct cache for URI 1. On the contrary, when a resource designated as URI 1 is requested, the inclusive cache corresponds to a case of having another resource including the requested resource despite not having a direct cache for URI 1. In particular, when a DM resource is requested through URI ‘./a/b/c?list=Struct’, if there is a cached resource version for ‘./a/b/c?list=Struct’, this is a direct cache. On the contrary, if there is a cached resource version for ‘./a/b?list=Struct’ despite not having such a direct cache, this is called an inclusive cache.

A cache validator is a sort of an indicator that provides information indicating whether a resource version cached in the local is a fresh version. In HTTP caching, ETag and Last-Modified are widely used as cache validators and a cache validator of the same type can be applied irrespective of a direct cache or an inclusive cache. In particular, both ETag and Last-Modified are applicable to each of the direct cache and the inclusive cache and can operate in the same manner.

According to the present invention, when a DM resource is exchanged between a DM server and a DM client, a method of utilizing an inclusive cache in addition to an existing direct cache is proposed. To this end, both an entity (e.g., a DM server in general) requesting a DM resource and an entity (e.g., a DM client in general) responding to a request should be changed.

<Requesting Process for DM Resource Caching>

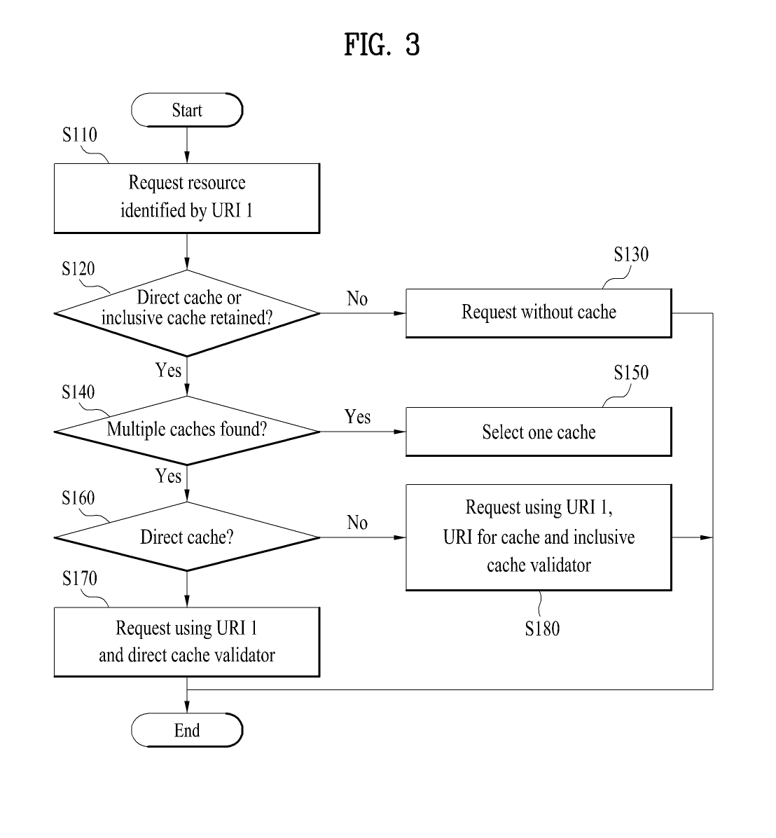

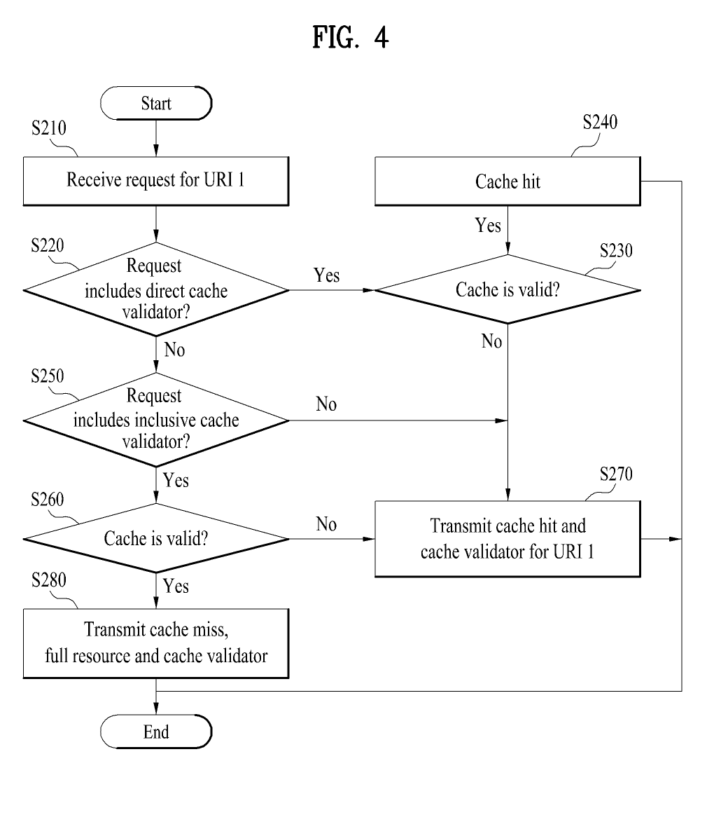

FIG. 3 is a flowchart of a process for making a request using an inclusive cache validator in requesting a resource in RESTful DM according to one embodiment of the present invention. It may be unnecessary for an entity requesting a DM resource to be a DM server. Yet, assume that a DM resource requesting entity is a DM server herein.

A DM server (DMS) 120 determines to make a request for a resource designated as URI 1 to a DM client (DMC) 110 [S110].

Before sending the request for the URI 1, the DM server 120 checks whether the DM server 120 has a cached resource [S120]. In this case, a cache may include a direct cache or an inclusive cache. Hence, a plurality of caches may be found in the present step.

The DM server 120 can search for an inclusive cache in various ways. For instance, the DM server 120 sets a parent node of a node, which corresponds to a resource to be requested, to a current node. The DM server 120 searches the current node for an inclusive cache validator for the resource to be requested. The DM server 120 sets a parent node of the current node to a new current node. And, the DM server 120 repeatedly performs the inclusive cache validator search and the new current node setting process until the inclusive cache validator for the resource to be requested is initially found.

Moreover, for instance, the DM server 120 searches a parent node of a node, which corresponds to a resource to be requested, to a root node of a DM tree for an inclusive cache validator for the resource to be requested.

If the DM server 120 has any caches, the DM server 120 sends a request to the DM client 110 without cache [S130]. In this case, the cache includes the URI 1 and its details may vary depending on a request content. Yet, since there is no cache, cache related information is not included in the request.

The DM server 120 checks whether a plurality of caches are found in the step S120 [S140].

If a plurality of the caches are found in the step S120, one of a plurality of the found caches is selected [S150]. Factors considerable to select the cache may include a cache type, a cache generation time, a cache range and the like.

In particular, the cache type indicates whether a corresponding cache is a direct cache or an inclusive cache. The direct cache enables cache validity determination simpler than that of the inclusive cache, thereby being effective.

According to the cache generation time, a cache generated later in time has a high probability of a cache hit. In this case, the cache hit means the following situation. First of all, when a cache client (e.g., CPU, web browser, operating system, etc.) accesses data estimated as existing in an auxiliary memory device, if a tag matching an entry of a desired data is found as an entry in checking caches, the corresponding entry is used instead of the data. In the following description, a cache hit may mean a situation that the cache validator received from the DM server 120 by the DM client 110 is valid.

According to the cache generation time, a cache generated later in time has a high probability of a cache hit.

According to the cache range, a cache having a narrower cache range has a higher probability of a cache hit and enables a simpler validity determination. In particular, since a cache including a wider range has a higher probability in updating a corresponding resource, a probability of a cache miss increases. In the following description, a cache miss may mean a situation that the cache validator received from the DM server 120 by the DM client 110 is not valid.

In order to raise the possibility of the cache hit, when a resource modification is traced, if a cache range gets wider, it is necessary to trace more resources. Hence, a load increases.

While the single cache is selected by the step S140 and the step S150, the DM server 102 checks whether the selected single cache is a direct cache or an inclusive cache [S160].

If the selected cache is the direct cache, the request for the DM resource follows the method of HTTO caching. In particular, the request for the DM resource includes URI 1 for the requested resource and a cache validator [S170]. In this case, since the cache validator is a direct cache validator, it is the cache validator directly used for the cached resource with the URI 1.

The present step corresponds to a case of making the DM resource using the inclusive cache validator. For the DM resource request, a request including the URI 1 (i.e., URI of the requested resource), the inclusive cache validator for the selected cache and the URI for the selected cache is sent to the DM client [S180].

<Responding Process for DM Resource Caching>

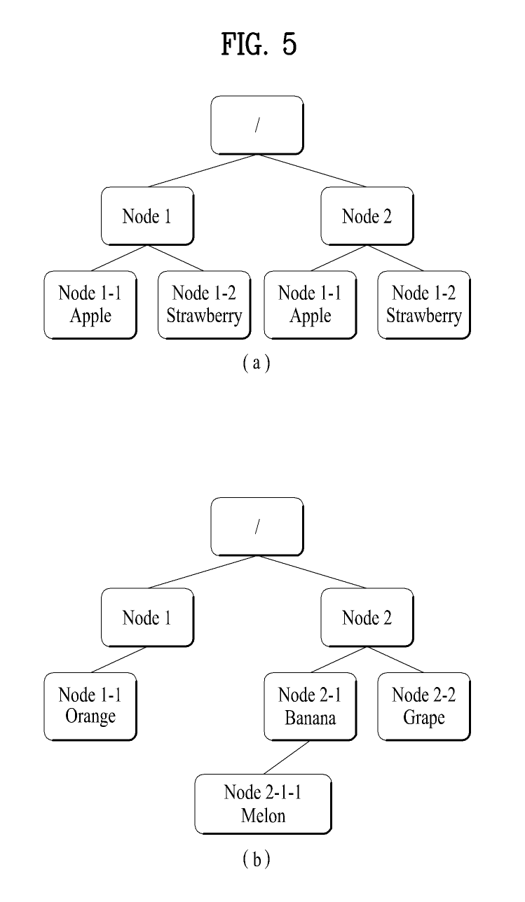

FIG. 4 is a flowchart of a process for a DM client to handle a received request for a DM resource according to one embodiment of the present invention. In this process regarded as a responding process, it may be unnecessary for a response processing part to be a DM client. Yet, the following description is made on the assumption that the response processing part is a DM client.

A DM client 110 receives a request for a DM resource with URI 1 from a DM server 120 [S210].

The DM client 110 checks whether a direct cache validator (e.g., ETag, Last-Modified, etc.) is included in a request message [S220]. If an If-None-Match field is included in an HTTP header, it means that the cache validator ‘ETag’ is included. If an If-Modified-Since field is included in the HTTP header, it can be determined that the cache validator ‘Last-Modified’ is included in the HTTP header.

Since a direct cache validator is a basic operation of HTTP cache, the present step coincides with the basic operation of HTTP. The DM client 110 can check whether a resource version cached by the DM server 120 is a fresh version through a cache validator [S230]. When the cache validator is ETag, if a value of ETag included in the request message matches an ETag value retained by the DM client 110, the DM client 110 determines that the corresponding cache is valid. Since the Last-Modified indicates a last modified time, it is able to determine validity by checking whether the corresponding resource has been modified after a last modification time included in the request.

As the cache is valid, if a cache hit is generated, since the version cached by the DM server 120 is a fresh version, the resource is not transmitted again [S240]. In HTTP, such a cache hit is notified in a manner of transmitting a status code ‘304 Not Modified’.

If there is no direct cache validator, the DM client 110 checks whether there is an inclusive cache validator [S250]. In case of RESTful DM, the inclusive cache validator can be delivered through an HTTP header as well. Yet, since a type of a cache validator is identified through a header name, used field names should differ from each other. For instance, in case of ETag, a header field named Inclusive-If-None-Match is available. In case of Last-Modified, a header field named Inclusive-If-Modified-Since is available. In case of the inclusive cache validator, unlike the direct cache validator, one additional URI should be further included in the HTTP header. This URI is an item called a URI for the cache described in the step S180 shown in FIG. 3 and indicates the resource cached in the local of the DM server 120 is a cache for a prescribed URI. If this URI is not included in the request message, it is unable to check a presence or non-presence of the validity of the cache. This is because the cache validator is not enough to find out that the corresponding cache is the cache for which resource. In order to represent this URI, a header named Inclusive-Cache-URI can be included in the HTTP header.

The DM client 110 checks whether the cache for the URI 1 cached in the local by the DM server 120 is valid using the received inclusive cache validator [S260]. In case of the inclusive cache validator, as mentioned in the foregoing description of the step S250, one additional URI is further included. This URI indicates that the inclusive cache validator is actually for a prescribed resource. In this case, this URI is assumed as IC_URI. A resource indicated by IC_URI includes the resource indicated by the URI 1 (Inclusive Relationship). The DM client 110 can check whether the resource for the IC-URI is modified through the inclusive cache validator of IC_URI. If the IC_URI resource is not modified, it means that the resource for the URI 1 is not modified. Although the resource indicated by IC-URI is modified, if the resource indicated by URI 1 is not modified, it can be determined that the cache for the URI 1 of the DM server 120 is valid. Yet, to this end, the DM client 110 caches a trace information on the modified DM resource and should then check whether each modification is the modification for the resource of IC-URI or the modification for the resource of URI 1.

As the cache is not valid, if a cache miss is generated, the DM client 110 sends a full resource (a full version of the resource) to the DM server 120 [S2780]. And, the DM client 110 sends the cache validator for the URI 1 of the transmitted resource as well. The transmitted cache validator may be used by the DM server 120 when the same resource is requested.

As the cache is valid, if a cache hit is generated, the DM client 110 needs not to send the resource again to the DM server 120. Yet, since the DM server 120 does not have a direct cache validator for the URI 1, the cache validator for the URI 1 is transmitted [S280]. This direct cache validator may be used if the DM server 120 requests the same resource later. This is because the direct cache is simpler than the inclusive cache in processing. HTTP uses a status code ‘304 Not Modified’ to notify a cache hit. By applying the same method to RESTful DM, the DM client 110 can inform the DM server 120 of the cache hit.

<Delta Response for Cache Miss>

As mentioned in the foregoing description with reference to the step S270 shown in FIG. 4, if the cash miss is generated, the DM client 110 transmits a full resource for the requested resource to the DM server 120. Yet, if a portion of the fully requested resource is modified only, it is inefficient to send the full resource (i.e., full version). In this case, it is able to send the modified portion of the full resource only, which is called a delta response.

FIG. 5 (a) and FIG. 5 (b) are diagrams to show modified contents of a DM tree according to one embodiment of the present invention.

The DM server 120 performs Get for a root on a DM tree shown in FIG. 5 (a), thereby caching a whole DM tree and a cache validator CV 1 for the root 1 in the local. In doing so, assume that the DM tree is updated as shown in FIG. 5 (b). When the update is performed, the cache validator for the root is updated as well. Assume that a new cache validator for the root is CV2. Now, if the DM server 120 performs Get on the root (1) with CV 1, the DM client 110 sends a full resource (full version) because the CV 1 is different from CV2 which is the cache validator for the root cached by the DM client 110. So far, this is the description with reference to FIG. 4.

Yet, if a modified portion is sent only instead of the full resource, it is more efficient. Thus, sending the modified portion only is called a delta response. And, the delta response may include an update of an existing node, an addition of a new node, a deletion of an existing node and the like.

<Description of One Embodiment of The Present Invention>

Table 7 in the following shows one example of a DM resource caching method using an inclusive cache in RESTful DM.

TABLE 7
Request 1
Get http://dev_ip:dm_port/SCOMO/Download?list=StructData HTTP/1.1
Response
HTTP/1.1 200 OKETag: “686897696a7c876b7e”// the resource
is here in the HTTP body
Request 2
GET http://dev_ip:dm_port/SCOMO/Download/game1?list=StructData
HTTP/1.1Inclusive-If-None-Match: “686897696a7c876b7e”Inclusive-
Cache-URI: http://dev_ip:dm_port/SCOMO/Download?list=StructData
Response 2
HTTP/1.1 304 Not ModifiedETag: “1234dfef31221233ffe3” // the ETag
for the URI requested// resource is not transferred

Details of Table 7 are described as follows. First of all, the DM server 120 makes a request for a resource for URI “http://dev_id:dm_port/SCOMO/Download?list=StructData” to the DM client 110 (Request 1).

Having received the request, the DM client 110 sends the corresponding resource to the DM server 120 (Response 1). The resource is sent through an HTTP body and the DM client additionally sends a cache validator. In Table 7, ETag is used as the cache validator.

The DM server 120 makes a request for ‘http://dev_ip:dm_port/SCOMO/Download/game1?list=StructData’ to the DM client 110 (Request 2). Since the request for the resource is initially made, a direct cache validator is not in the local. Yet, since the request for ‘http://dev_id:dm_port/SCOMO/Download?list=StructData’ was previously made, it is a case that the DM server 120 has an inclusive cache. In order to enable the inclusive cache to be included in the request message, a field Inclusive-If-None-Match and a field Inclusive-Cache-URI are used. The field Inclusive-If-None-Match is used to deliver an inclusive cache validator and the field Inclusive-Cache-URI indicates that the inclusive cache actually corresponds to a cache for a prescribed resource.

Using the inclusive cache validator, the DL client 110 checks whether the cache of the DM server 120 for the ‘http://dev_ip:dm_port/SCOMO/Download/game1?list=StructData’ actually requested by the DM server 120 is valid (Response 2). The DL client 110 checks whether the resource ‘http://dev_id:dm_port/SCOMO/Download?list=StructData’ is modified through the inclusive cache validator delivered through the Inclusive-If-None-Match. If the ‘http://dev_id:dm_port/SCOMO/Download?list=StructData’ is not modified, it means that a subordinate resource ‘http://dev_ip:dm_port/SCOMO/Download/game1?list=StructData’ is not modified as well. Hence, it can be determined that the cache is valid. Moreover, although the resource ‘http://dev_id:dm_port/SCOMO/Download?list=StructData’ is changed, if the resource ‘http://dev_ip:dm_port/SCOMO/Download/game1?list=StructDatai is not modified according to the trace of the modified content, it can be determined that the cache is valid.

<Lightweight Resource Caching for DM>

So far, the DM resource caching method using the inclusive cache is explained in the above description. Yet, although this method is efficient in consideration of an inclusive relationship between DM resources, it is disadvantageous in that considerable load is put on a terminal. Such load is mainly generated from managing a cache validator used for caching. A cache validator should be provided to each URI requested by the DM server 120. Each time a corresponding resource is updated, a related cache validator should be updated. In particular, the DM client 110 should manage a cache validator for an interior node ‘/a/b’ in manner of regarding each property such as ‘/a/b’, ‘./a/b?list=Struct’, ‘./a/b?list=StructData’, ‘./a/b?list=MORoot’, ‘./a/b?list=MORootData’, ‘./a/b?list=TNDS’ and the like as a separate resource. Since such overhead may be the cause of performance degradation of a terminal, an efficient and lightweight DM resource caching method is required. In the following description, a lightweight DM resource caching method is proposed.

A DM tree caches a node value in a leaf node and stores data related to a node through such a node property as ACL (Access Control List), Format, Name, Size, Title, TStamp, Type, VerNo and the like. Although these data are cacheable resources, the node name and the node value are specially significant resources. Hence, for lightweight DM resource caching, node URI (sequence of node name) and node value are cached. Moreover, one cache validator is assigned to each node and managed. In particular, without providing a separate cache validator for an interior node ‘./a/b’ to each URI such as “./a/b”, “./a/b?list=Struct”, “./a/b?list=StructData”, “./a/b?list=MORoot”, “./a/b?list=MORootData”, “./a/b?list=TNDS” and the like, one cache validator is provided to the node “./a/b”. This content is summarized as follows.

First of all, one cache validator is assigned to a node only. And, one node has one cache validator only.

A cache validator assigned to a leaf node covers a node URI and node value of the leaf node. If the node URI and node value of the leaf node are updated, the cache validator of the leaf node is updated.

A cache validator assigned to an interior node covers a node URI of the interior node, node URIs of all child nodes (all nodes except an interior node in a subtree having the interior node as a root), and node values of all child nodes. If the node URI of the interior node, the node URIs of all child nodes and the node values of all child nodes are updated, the cache validator for the interior node should be updated.

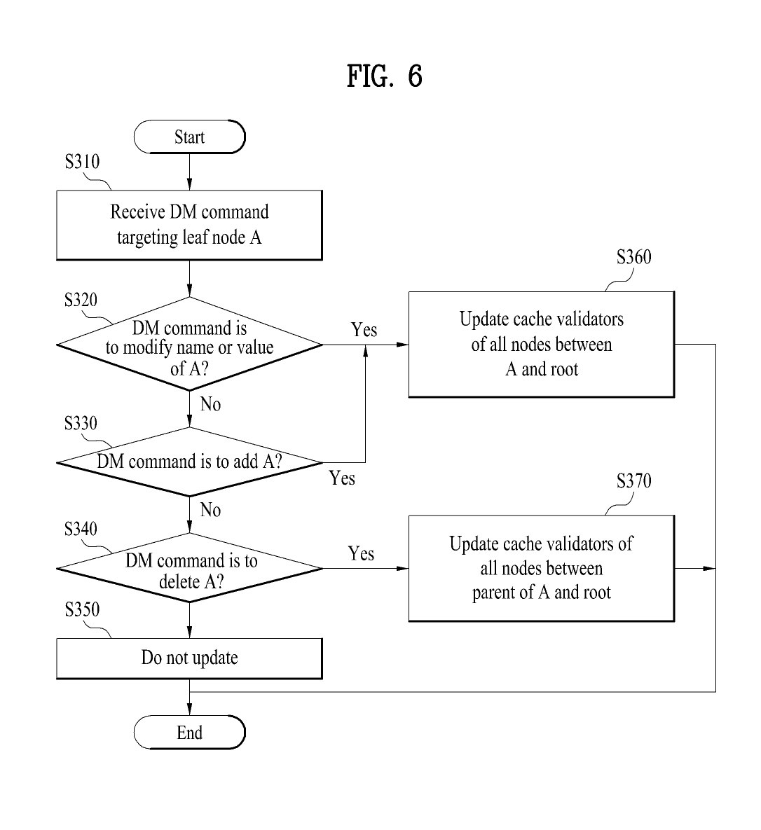

Since a node URI is generally configured in a root node in a manner of connecting node names and delimiters of all nodes reaching the root node, a modification of the node name eventually brings modifications of the node URI of the corresponding node and the node URIs of child nodes of the corresponding node. In DM, there is no command for directly modifying a node URI but the node URI can be modified in a manner of modifying a name of the node. Hence, in FIG. 6, a node URI modification is checked using a node name modification.

FIG. 6 is a flowchart of a process for updating a cache validator of a leaf node according to one embodiment of the present invention.

The DM client 110 receives a command, which targets a leaf node A, from the DM server 120 [S310].

The DM client 110 checks whether the DM command is a command for modifying an existing node, and more particular, a command for modifying a name or value of a leaf node [S320].

The DM client 110 checks whether the DM command is a command for newly adding a node A [S330].

The DM client 110 checks whether the DM command is a command for deleting an existing node A [S340].

If the DM command is not to modify/add/delete the node name or the node value, the DM client 110 does not update a cache validator [S350].

If the node name or the node value is modified or a node is newly added, the DM client 110 updates cache validators of all nodes (e.g., all nodes on a shorted path from the node A to a root node) from the node A to the root node [S360].

If the node name or the node value is deleted, the DM client 110 updates cache validators of all nodes (e.g., all nodes on a shortest path from a parent node of A to the root node) from the parent node of A to the root node [S370].

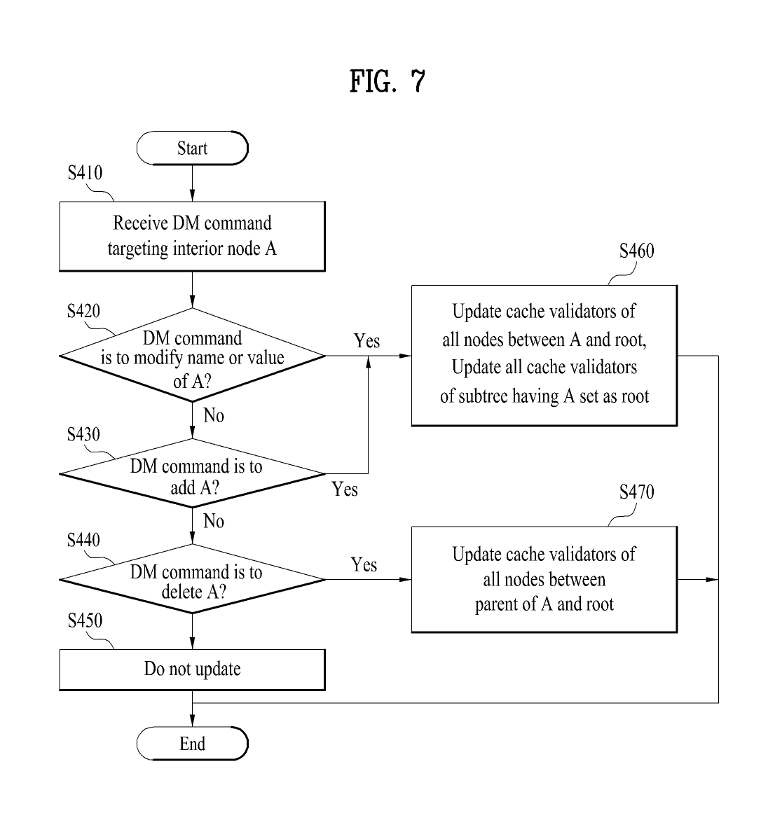

FIG. 7 is a flowchart of a process for updating a cache validator of an interior node according to one embodiment of the present invention.

The DM client 110 receives a command, which targets an interior node A, from the DM server 120 [S410].

The DM client 110 checks whether the DM command is a command for modifying a node name of A [S420].

The DM client 110 checks whether the DM command is a command for newly adding a node A [S430].

The DM client 110 checks whether the DM command is a command for deleting a node A [S440].

If the DM command is not to modify the node name or not to add/delete a node, the DM client 110 does not update a cache validator [S450].

If the DM command is to modify the node name or to add a node, the DM client 110 updates cache validators of all nodes (e.g., all nodes on a shorted path from the node A to a root node) from the node A to the root node. And, the DM client 110 updates cache validators of al nodes in a subtree having the A as the root node [S460]. In doing so, since the cache validator of the node A is already updated, a redundant update is not performed.

If the DM command is to delete the node A, the DM client 110 updates cache validators of all nodes (e.g., all nodes on a shortest path from a parent node of A to the root node) from the parent node of A to the root node [S470].

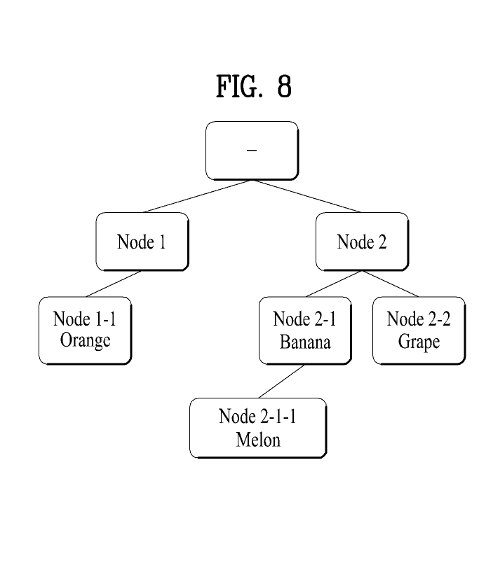

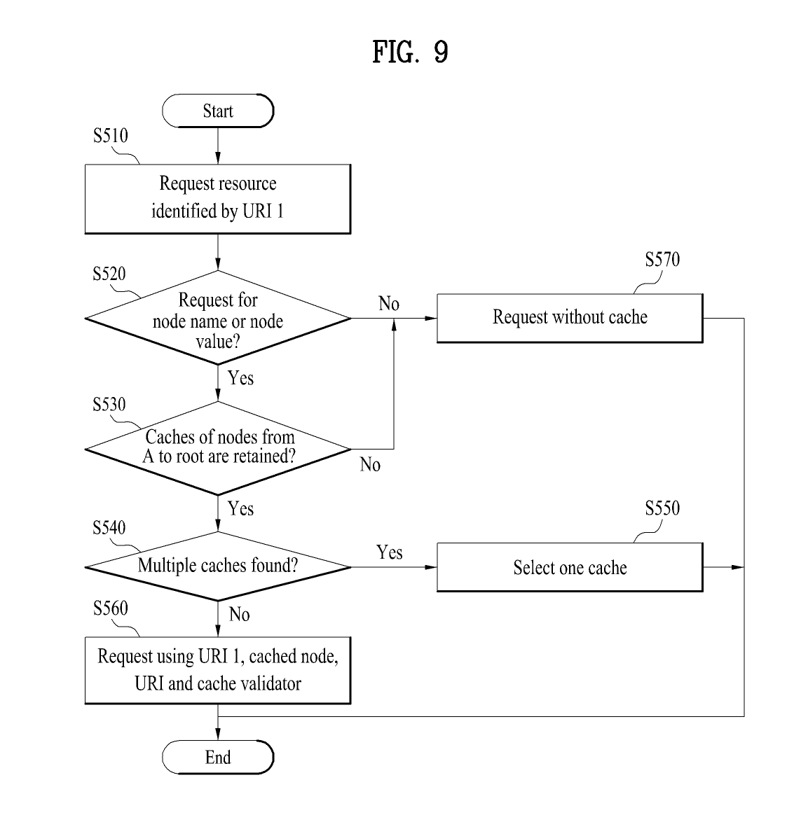

FIG. 8 is a diagram for a concept of a process for updating a cache validator shown in FIG. 6 and FIG. 7.

Since total 7 nodes including a root node exist in a DM tree shown in FIG. 8, a terminal manages total 7 cache validators, and more particularly, one cache validator for each node. Hence, the number of cache validators can be further reduced than that of cache validators in case of providing one cache validator to each URI. If a node value of node 1-1 is modified into ‘apple’, the DM client 110 updates the cache validators of node 1-1, node 1 and root node. If a node 2-1-1 is deleted, the DM client 110 updates cache validators of node 2-1, node 2 and root node. If node 2-2 is newly added, the DM client 110 updates cache validators of node 2-2, node 2 and root node. If a name of node 2 is modified, the DM client 110 updates cache validators of node 2, root node, node 2-1, node 2-2 and node 2-1-1.

<Resource Request from DM Server>

A resource request using a lightweight resource caching is similar to the resource requesting method described with reference to FIG. 3. Yet, the lightweight resource caching uses a node-based cache validator, whereas the resource requesting method shown in FIG. 3 uses a URI based cache validator. And, the cache validator covers a node URI and a node value only. Hence, there is a difference between the lightweight resource caching and the resource requesting method shown in FIG. 3.

FIG. 9 is a flowchart of a process for a DM server to make a request for a resource to a DM client by lightweight resource caching according to one embodiment of the present invention.

The DM server 120 determines to make a request for a resource designated as URI 1 to the DM client 110 [S510]. In this case, the URI 1 indicates a specific node A. For instance, a URI named “./a/b?list=Struct” indicates a node “./a/b”. And, a URI “./a/b” indicates a node “./a/b” as well.

The DM server 120 checks whether a resource to be requested is a node name or a node value [S520]. This is because a node name and a node value are cached only. For instance, a local cache does not exist for a request for ACL value. For instance, if the resource to be requested is “./a/b?list=Struct”, “./a/b?list=StructData”, or “./a/b”, it corresponds to a node name or a node value. Yet, if the resource to be requested is “./a/b?prop=ACL” or “./a/b?prop=Title”, it does not correspond to a node name or a node value.

The DM server 120 searches for a local cache including the resource to be requested [S530]. If any one of all nodes from a node A to a root node has a cache, it corresponds to the local cache.

The DM server 120 checks whether the number of the cache(s) found in the step S530 is plural [S540].

If it is confirmed that several caches are found in the step S540, the DM server 120 selects one of the several caches [S550]. For instance, the DM server 120 can select one of the several caches with reference to a cache generation time and a cache range.

According to the cache generation time, a cache generated later in time has a high probability of a cache hit. According to the cache range, a cache having a narrower cache range has a higher probability of a cache hit and enables a simpler validity determination. In particular, since a cache including a wider range has a higher probability in updating a corresponding resource, a probability of a cache miss increases.

If the local cache exists, the DM server 120 requests a resource using the cache. The DM server 120 sends a request message in which a requested resource URI 1, a URI of a caching node and a cache validator are contained. If the URI 1 requested in FIG. 8 is “./node2-1?list=StructData” and has a local cache for “./node2”, the resource is requested to (“./node2-1?list=StructData”, “./node2”, CV 1). In this case, the CV 1 is a cache validator for “./node2”. If the node indicated by the requested resource URI 1 matches the cached node, the cached node URI can be omitted and the DM server 120 requests the URI 1 using the URI 1 and the cache validator only.

If the local cache including the resource to be requested does not exist, the DM server 120 requests the URI 1 without a cache [S570].

<Response from DM Client>

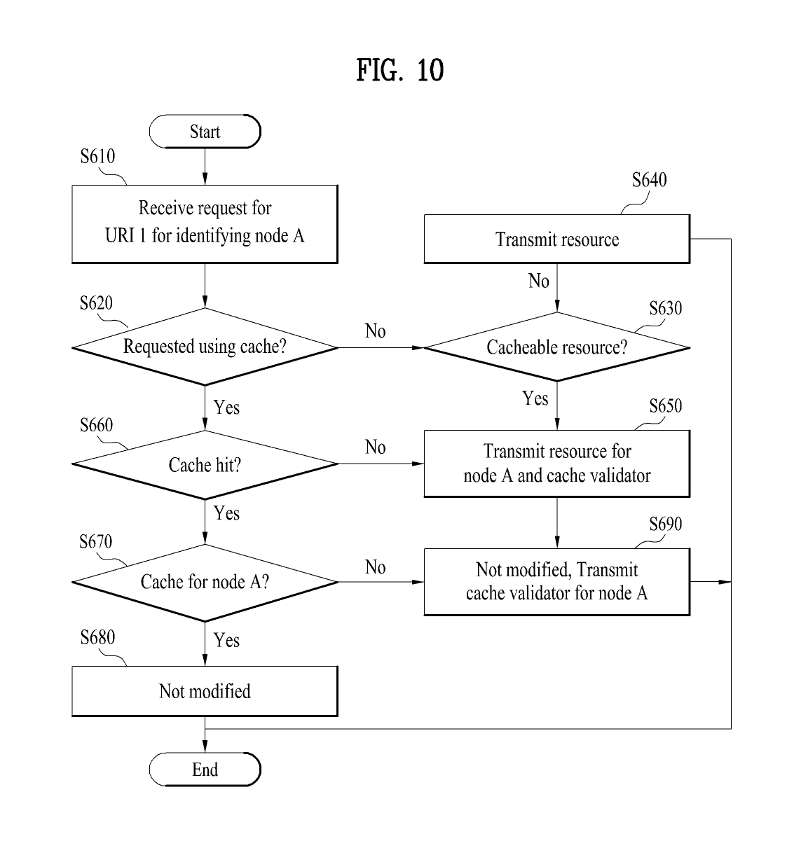

FIG. 10 is a flowchart of a process for a DM client to respond to a DM server by lightweight resource caching according to one embodiment of the present invention.

The DM client 110 receives a request for URI 1 [S610]. In this case, the URI 1 indicates a node A. For instance, a URI named “./a/b?list=Struct” indicates a node “./a/b”. And, a URI named “./a/b” indicates a node “./a/b” as well.

The DM client 110 determines whether the request is a resource request using a cache. If a cache validator is included, it is the resource request using the cache [S620].

The DM client 110 checks whether the requested resource is a cacheable resource [S630]. If a node name and a node value are requested, the request is the request for the cacheable resource.

The DM client 110 sends the requested resource to the DM server 120 [S640]. If the requested resource is a non-cacheable resource, it is unnecessary to send a cache validator.

The DM client 110 sends the requested resource and a cache validator for the node A together [S650].

In case of the resource request using the cache in the step S620, a URI 1, a cached node URI and CV 1 are included in the request. In this case, the DM client 110 checks whether it is cache hit [S660]. If a cache validator cached for the cached node URI by the DM client 110 matches the CV 1, the DM client 110 can determine it as the cache hit. If the it is not the cache hit, the DM client 110 sends the requested resource and the cache validator for the node A together [S650].

In the step S660, in case of the cache hit, the DM client 110 checks whether it is the cache for the node A [S670]. If a node A URI matched the cached node URI included in the request, it is the cache for the node A.

If the cache validator for the node A is present in the step S670, the DM client 110 sends ‘Not Modified’ to the DM server 120 [S680].

If the DM server 120 does not have the cache validator for the node A in the step S670, the DM client 110 sends the cache validator for the node A cached by the DM client 110 to the DM server 120 together [S690].

<Response Processing in DM Server>

In the following description, a process for the DM server 120 to process a response received from the DM client 110 is explained. In FIG. 10, the steps responded by the DM client 110 include the step S640, the step S650, the step S680 and the step S690.

In the step S640, since the request made by the DM server 120 is the request for the non-cacheable resource, the DM server 120 uses the resource received from the DM client 110 without separate processing.

In the step S650, since the resource and the cache validator corresponding to the resource are received from the DM client 110, the DM server 120 caches the received resource in the local.

In the step S680, since a content in the local cached of the DM server 120 is a fresh version of the resource, the DM server 120 uses the resource cached in the local.

In the step S690, since the resource cached in the local is a fresh version, the DM server 120 uses the cached resource and saves the received cache validator as the cache validator for the node A.

<Cache Validator Node (CV Node)>

In the above description, so far, the lightweight resource caching method is explained. The lightweight resource caching provides one cache validator to each node and is a method for the cache validator to cover a node name and a node value only. In the following description, a method for several selected nodes to have cache validators is explained. According to this method, since a cache validator is not provided to every node, it is able to reduce overhead of a terminal.

A cache validator node (CV node) means a node to which a cache validator may be assigned. In particular, a node designated as a CV node can have a cache validator. Thus, MO root node is a representative example of the node designated as the CV node. In case of such a small MO as DevInfo, DevDetail and the like, it is enough for the MO root node to become the CV node only. Yet, since a size of such an MO as SCOMO is large, “./SCOMO/Download”, “./SCOMO/Inventory/Delivered” and “./SCOMO/Inventory/Deployed” can be designated as CV nodes as well as the MO root. What kind of node shall be assigned as CV node is individually determined for each MO.

The benefit of the CV node introduction lies in that the number of cache validators supposed to be managed by a terminal can be considerably decreased. In case of DevInfo, there are at least 5 nodes including an MO root. Hence, in case that a cache validator is provided to each node, total 6 cache validators are required. Yet, if MO root is designated to the CV node only, the number of the cache validators can be decreased to 1.

In case of utilizing the CV node, a cache validator update is basically equal to the former update method described with reference to FIG. 6 and FIG. 7. Yet, a cache validator is updated for the CV node only. This is because a node other than the DV node is unable to have a cache validator. In the steps S360 and S370 shown in FIG. 6, the cache validator update is performed on the CV node only. Likewise, in the steps S460 and S470 shown in FIG. 7, the cache validator update is performed on the CV node only. And, the resource requesting method of equal to the former resource requesting method described with reference to FIG. 9. Namely, since the node not designated as the CV node does not have a cache validator, it is just represented as not cached in the step S530. A responding method of the DM client 110 is basically equal to the former responding method described with reference to FIG. 10. Yet, in the step S650 and the step S690, a cache validator is not always sent to the node A. Only if the node A is the CV node, the cache validator is sent. This is because a node other than the CV node is unable to have a cache validator.

<MO Request in DM Notification Using Caching>

When terminal management of the DM client 110 is necessary, the DM server 120 sends a DM notification to the DM client 110. Having received the DM notification, the DM client 110 establishes a DM session with the DM server 120 and then receives device management from the DM server 120. The DM server 120 inserts an MO index in the DM notification. Hence, the corresponding MO can be received in ‘PKG #1’. The MO index includes 2-byte numeral. Like MOID, the MO index is used as an identifier for a specific MO. The reason why the MO index is used is because a length of the MO index is smaller than that of a plain text based MOID. Thus, if the MO index is used in the DM notification, the corresponding MO data can be received in ‘PKG #1’, whereby respondence can be considerably enhanced.

In case that a specific MO is requested in ‘PKG #1’ in a manner of inserting the MO index in the DM notification, caching can be applied in the following manner.

First of all, the DM server 120 checks whether an MO root of MO to be requested is designated as a CV node. If the MO root is the CV node, the caching is applicable. If the DM server 120 has a cache validator for the MO root node, the DM server 120 inserts an MO index and a cache validator for an MO root in the DM notification and then sends the DM notification to the DM client 110. For instance, if an MO index of DevInfo MO, a DevInfo MO root URI and a cache validator of “./DevInfo” retained by the DM server 120 are 100, “./DevInfo” and CV 1, respectively, the DM server 120 sends the DM notification including ‘100, CV1’. The DM client 110 then sends a response ‘PKG #1’.

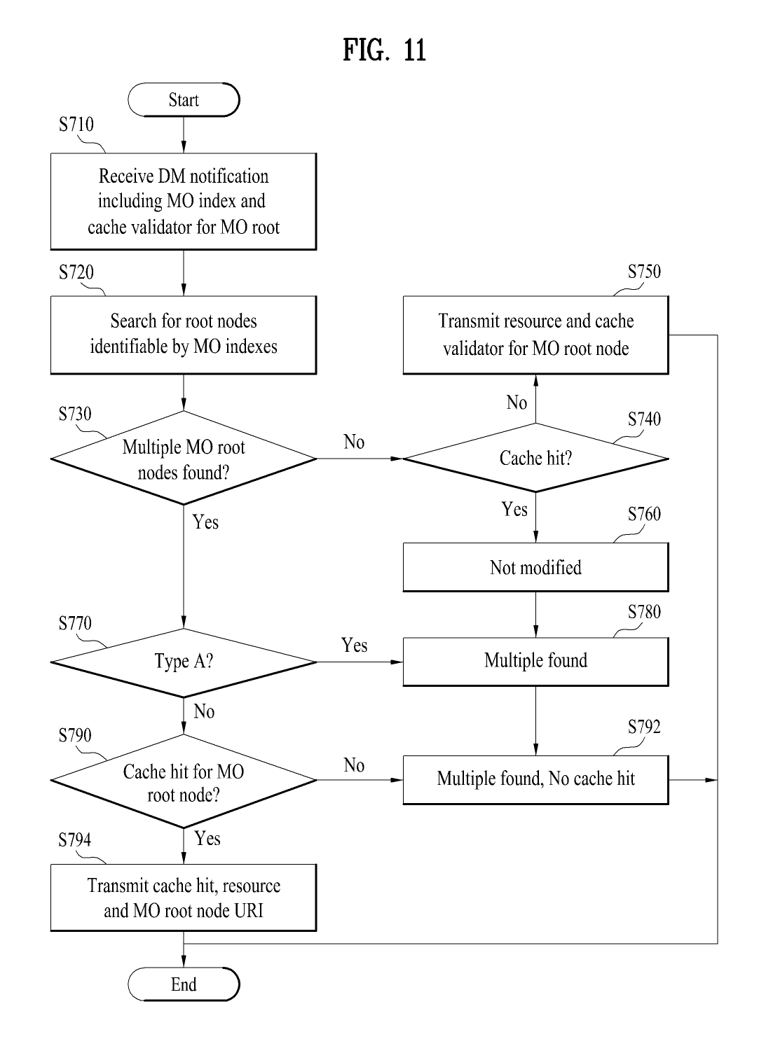

FIG. 11 is a flowchart of a process for a DM client 110 to send a response with PKG #1 according to one embodiment of the present invention.

The DM client 110 receives a DM notification from the DM server 120 [S710]. In this case, assume that an MO index and a cache validator for an MO rot are included in the DM notification. If there is no MO index or the cache validator is not included despite that the MO index is included, Definition of DM 1.3 is followed.

The DM client 110 searches a DM tree for an MO root node indicated by the MO index [S720]. First of all, MOID matching the MO index is obtained. Secondly, all nodes are searched using the MOID. In this case, a found node is the MO root node.

It is checked whether the number of the MO root node(s) found in the step S720 is plural [S730]. In case that the number of the MO root nodes found in the step S720 is plural, the routine may proceed in a manner of either Type A or Type B. According to Type A, the routine goes to the step S780. According to Type B, the routine goes to the step S790.

In case that 1 MO root node is found in the step S720, the found MO root node is the CV node. This is because the cache validator is sent only if the MO root node of the MO requested by the DM server 120 is the DV node. The DM client 110 checks whether the cache validator retained by the DM client 100 for the found MO root node matches the cache validator sent by the DM server 120 [S740], if the two cache validators match each other, the DM client 110 determines that it is a cache hit.

In case of a cache miss, the DM client 110 additionally sends the cache validator for the MO root node to the DM server 120.

In case that a local cache retained by the DM server is a fresh version, the DM client 110 sends ‘Not Modified’ to the DM server 120 [S760].

In the step S770, either DM Type A or DM Type B is selected.

In case of Type A, a cache validator is assigned to a specific node and then updated. And, the cache validator is meaningful for the corresponding specific node only. Hence, in case of attempting to compare cache validators for the cache hit check, a node of a comparison target should be determined in the first place. Yet, in case that multiple MO roots are found, it is unable to specify a compared MO root node. Hence, the corresponding comparison is difficult. Hence, the DM client 110 sends a message ‘Multiple Found’ to the DM server 120 [S780].

In case of Type B, in case that multiple MO roots are found, the DM client 110 checks whether the cache validator (i.e., this cache validator exists only if the MO root node is the CV node) of the MO root node matches the cache validator sent by the DM server 120 [S790].

Although multiple MO roots are found, if a cache hit MO root node does not exist, the DM client 110 sends a message ‘Multiple found, no cache hit’ to the DM server 120 but does not transmit MO data [S792]. This is because it is unable to know which one of the multiple MO data should be sent.

The DM client 110 sends the MO data for the MO root node having the cache validator matching the cache validator sent by the DM server 120 among the found multiple MO root nodes to the DM server 120. Since the multiple MO root nodes are found, the DM client 110 additionally sends an MO root node URI to inform the DM server 120 of the corresponding MO root node [S794].

### Alternative Embodiments

In the following description, other embodiments of the present invention are explained. So far, in the foregoing description, a method of caching a DM resource using inclusive caching in RESTful DM is explained, Yet, the RESTful DM is a sort of transport binding for delivering a DM message between the DM server 120 and the DM client 110 and is not a core function of DM protocol. Namely, HTTP binding, OBEX binding or the like us usable as DM transport binding. In this case, it is unable to use the caching of the RESTful DM mentioned in the foregoing description. In the following description, a method of caching a DM resource using inclusive caching on DM protocol level is explained. This DM resource caching on the DM protocol level is a caching method independent from the transport binding and is advantageous in using the DM resource caching irrespective of the transport binding.

Table 8 in the following shows a method of caching a DM resource using a direct cache on a DM protocol level.

TABLE 8
Request 1
<Get><CmdID>4</CmdID><Item><Target><LocURI>./
antivirus_data/version</Loc URI></Target></Item></Get>
Response 1
<Results><CmdRef>4</CmdRef><CmdID>3</CmdID><Item><Source>
<LocURI>. /antivirus_data/version</LocURI></Source><Data>antivirus-
inc/20010522b/5</Data ></Item><ETag>686897696a7c876b7e</
ETag> <!- cache validator for ./antivirus_data/version --></Results>
Request 2
<Get><CmdID>4</CmdID><Item><Target><LocURI>./antivirus_data/
version</Loc URI></Target></Item><IfNoneMatch>
686897696a7c876b7e </IfNoneMatch></Get>
Response 2
<Results><CmdRef>4</CmdRef><CmdID>3</CmdID><NotModified/>
</Results>

In the following description, the respective steps are explained in detail. It is not mandatory for the DM server 120 to make a request for a DM resource. Yet, in Table 8, assume a case that the DM server 120 makes a request for a DM resource.

The DM server 120 makes a request for a DM resource “./antivirus_data/version” to the DM client 110 (Request 1).

Since a cache validator is not included in a request message, the DM client 110 makes a full response. The DM client 110 transmits data for the request to the DM server 120 in a manner that the data is included in an element <Item>. In doing so, ETag is used as a cache validator for “./antivirus_data/version” and an element <ETag> is used to deliver Etag value. A use of the element <ETag> is just one example and another element can be used (Response 1).

DMS makes a request for the same DM resource “./antivirus_data/version” again. In doing so, the Etag value previously received from the DM client 110 is transmitted together. To this end, an element <IfNoneMatch> is used (Request 2).

The DM client 110 checks cache validity indicating whether “./antivirus_data/version” is modified from the cache validator for “./antivirus_data/version”. If determining that the cache is valid, the DM client 110 transmits <NotModified> to inform the DM server 120 of a cache hit (Response 2).

Table 9 in the following shows a method of caching a DM resource using an inclusive cache on a DM protocol level.

TABLE 9
Request 1
<Get><CmdID>4</CmdID><Item><Target><LocURI>./SCOMO/Download?list=Struct
Data</LocURI></Target></Item></Get>
Response 1
<Results><CmdRef>4</CmdRef><CmdID>3</CmdID><Item><Meta> <Format
xmlns=’syncml:metinf’>node</Format> </Meta> <Source>
<LocURI>./SCOMO/Download</LocURI> </Source></Item><Item> <Meta>
<Format xmlns=’syncml:metinf’>node</Format> </Meta> <Source>
<LocURI>./SCOMO/Download/game1</LocURI> </Source> </Item>... The rest of
items are here...<ETag>686897696a7c876b7e</ETag> <!- cache validator for
./SCOMO/Download?list=StructData --></Results>
Request 2
<Get><CmdID>4</CmdID><Item><Target><LocURI>./SCOMO/Download/game1?
list=StructData</LocURI></Target></Item><InclusiveCacheURI>./SCOMO/Download
?list=StructData</InclusiveCacheURI><IfNoneMatch>686897696a7c876b7e</IfNone
Match></Get>
Response 2
<Results><CmdRef>4</CmdRef><CmdID>3</CmdID><NotModified/><ETag>123
1211gea2121fe223</ETag> <!- cache validator for
./SCOMO/Download/game1?list=StructData --></Results>

In the following description, the respective steps are explained in detail. It is not mandatory for the DM server 120 to make a request for a DM resource. Yet, in Table 9, assume a case that the DM server 120 makes a request for a DM resource.

The DM server 120 makes a request for a DM resource “./SCOMO/Download?list=StructData” to the DM client 110 (Request 1).

Since a cache validator is not included in a request message, the DM client 110 makes a full response. The DM client 110 transmits data to the DM server 120 through an element <Item> and also transmits ETag for “./SCOMO/Download?list=StructData” together (Response 1).

The DM server 120 makes a request for “./SCOMO/Download/game1?list=StructData”. Since the DM server 120 has not requested this DM resource, it does not retain a direct cache. Yet, since the DM server 120 has requested the “./SCOMO/Download?list=StructData” including this resource, the DM server 120 retains an inclusive cache. When the DM server 120 sends a request message, in order to utilize the inclusive cache, the DM server 120 sends two kinds of informations in addition. One is an inclusive cache validator and is delivered through an element <IfNoneMatch>. The other is an inclusive cache URI indicating that the inclusive cache is actually provided for a prescribed resource and is delivered through <InclusiveCacheURl> (Request 2).

DMC checks validity of a cache through the inclusive cache validator. If determining that the cache is valid, the DMC sends an element <NotModified/> to indicate a cache hit. The DMC then sends ETag for “./SCOMO/Download/game1?list=StructData” to use a direct cache later (Response 2).

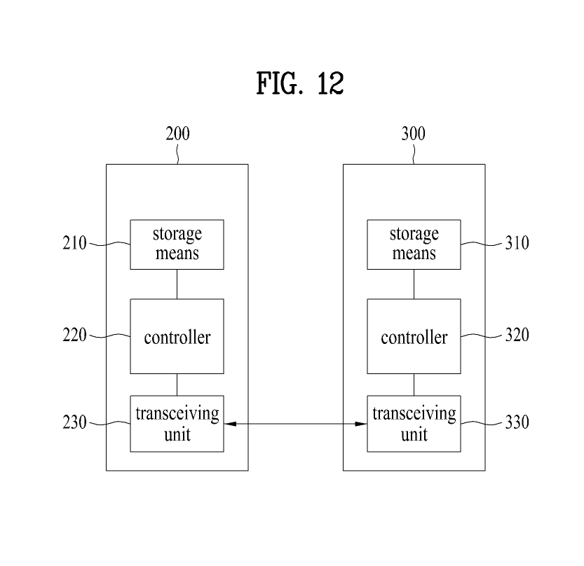

FIG. 12 is a block diagram of a terminal 200 and a server 300 according to one embodiment of the present invention.

Referring to FIG. 12, a terminal 200 includes a storage means 210, a controller 220 and a transceiving unit 230. The storage means 210 stores the methods according to the embodiments described with reference to FIGS. 1 to 11. The controller 220 controls the storage means 210 and the transceiving unit 230. In particular, the controller 220 activates the methods saved in the storage means 210. And, the controller 220 transmits the aforementioned signals through the transceiving unit 230.

Referring to FIG. 12, a server 300 includes a storage means 310, a controller 320 and a transceiving unit 330. The storage means 310 stores the methods according to the embodiments described with reference to FIGS. 1 to 11. The controller 320 controls the storage means 310 and the transceiving unit 330. In particular, the controller 320 activates the methods saved in the storage means 310. And, the controller 320 transmits the aforementioned signals through the transceiving unit 330.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A method of obtaining a resource, which is obtained by a device management server from a device management client, the method comprising:
determining whether a cache validator of a first type for a first resource exists, wherein the cache validator of the first type is directly used for the first resource;
determining whether a cache validator of a second type for the first resource exists, wherein the cache validator of the second type is used for a second resource including the first resource, when the cache validator of the first type for the first resource does not exist; and
transmitting a request for the first resource to the device management client using an identifier for the first resource, an identifier for the second resource and the cache validator for the second resource, when the cache validator of the second type for the first resource exists.

2. The method of claim 1, wherein a first node associated with the first resource and a second node associated with the second resource are included in a device management tree.

3. The method of claim 2, wherein the step of determining whether the cache validator of the second type for the first resource exists comprises:
searching a current node for the cache validator of the second type for the first resource;
setting a parent node of the current node to the current node; and
repeating the searching step and the setting step until the cache validator of the second type for the first resource is initially found,
wherein the current node is initially set to a parent node of the first node.

4. The method of claim 2, the step of determining whether the cache validator of the second type for the first resource exists comprises:
searching at least one cache validator of the second type for the first resource from a parent node of the first node to a root node of the device management tree.

5. The method of claim 4, the step of determining whether the cache validator of the second type for the first resource exists comprises:
selecting the cache validator of the second type for the first resource from the at least one cache validator of the second type for the first resource.

6. The method of claim 1, wherein each of the first resource and the second resource comprises a network data object or service identifiable by a corresponding identifier.

7. The method of claim 1, further comprising:
transmitting the request for the first resource to the device management client using an identifier for the first resource and the cache validator for the first resource, when the cache validator of the first type for the first resource exists.

8. The method of claim 1, further comprising:
transmitting the request for the first resource to the device management client using an identifier for the first resource, when the cache validator of the first type for the first resource does not exist.

9. A method of providing a resource, which is provided to a device management server by a device management client, the method comprising:
receiving a request for a first resource from the device management server, wherein the request includes a cache validator of a first type or a second type for the first resource, wherein the cache validator of the first type is directly used for the first resource, and wherein the cache validator of the second type is used for a second resource including the first resource;
sending a message indicating that the first resource is not modified to the device management server, when the request includes the cache validator of the first type, and the cache validator of the first type is valid for the first resource; and
sending the message to the device management server, when the cache validator of the second type is valid for the second resource, and the request includes the cache validator of the second type.

10. The method of claim 9, the step of sending the message when the cache validator of the second type is valid for the second resource comprises:
sending the message using the cache validator of the first type, when the cache validator of the first type for the first resource cached in the device management client exists.

11. The method of claim 9, further comprising:
transmitting the first resource to the device management client, when the cache validator of the first type is not valid for the first resource or the cache validator of the second type is not valid for the second resource.

12. The method of claim 11, the first resource transmitting step comprises:
transmitting the cache validator of the first type together with the first resource, when the cache validator of the first type for the first resource cached in the device management resource exists.

13. The method of claim 9, wherein a first node associated with the first resource and a second node associated with the second resource are included in a device management tree.

14. The method of claim 9, wherein each of the first resource and the second resource comprises a network data object or service identifiable by a corresponding identifier.
